(19) United States
(12) Patent Application Publication
(10) Pub. No.: US 2025/0063047 A1
(43) Pub. Date: Feb. 20, 2025

(54) SYSTEMS AND METHODS FOR TEMPORARY PRIVILEGED CLUSTER ACCESS

(71) Applicant: Dell Products, L.P., Round Rock, TX (US)

(72) Inventors: Brandon Myers, Durham, NC (US); Eric T. Stouch, Raleigh, NC (US); Gregory W. Lazar, Upton, MA (US); Kristian Comer, Hudson, NH (US)

(73) Assignee: Dell Products, L.P., Round Rock, TX (US)

(21) Appl. No.: 18/449,920

(22) Filed: Aug. 15, 2023

(51) Int. Cl. H04L 9/40

(52) U.S. Cl. CPC H04L 63/10; H04L 63/062

(57) ABSTRACT

Systems and methods for providing secure temporary privileged access to computing devices configured in a cluster are disclosed. According to one embodiment, an Information Handling System (IHS) includes a cluster configured with multiple computing devices, and computer-executable instructions to obtain a temporary key, and distribute the temporary key to each of the computing devices, wherein each of the computing devices stores its copy of the key. Using the temporary key, the instructions establish a temporary secure communication channel with each of the computing devices, perform a task on each of the computing devices using the secure communication channel, and cancel the secure communication channel when the task is finished.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

Various hardware components of an IHS may operate using firmware instructions. From time to time, it is expected that firmware utilized by hardware components of an IHS may be updated. Such firmware updates may be made in order to modify the capabilities of a particular hardware component, such as to address security vulnerabilities or to adapt the operations of the hardware component to a specific computing task. When firmware updates are made to a hardware component of an IHS, it is preferable that the IHS experience no downtime and with minimal degradation in the performance of the IHS.

Nowadays, software updates are typically made available on one or more download sites as soon as the software provider can produce them. In this manner, software providers can be more responsive to critical flaws, security concerns, and general customer needs. As a result, to update software, a customer would query an update site for software updates, and download and install the software update if available. For example, a typical network-based software update procedure may include the steps of issuing a request over a network to a software provider's download site (e.g., update source) for a software update applicable to the client computer. The update source responds to the client computer with the software update requested by the client computer in the update request. After the client computer has received the software update, the client computer installs the received software update.

One benefit of updating software in such a manner is the reduced cost associated with producing and distributing software updates. Additionally, software updates can now be performed more frequently, especially those that address critical issues and security. Furthermore, a computer user has greater control as to when and which software updates should be installed on the client computer.

### SUMMARY

Systems and methods for providing secure temporary privileged access to computing devices configured in a cluster are disclosed. According to one embodiment, an Information Handling System (IHS) includes a cluster configured with multiple computing devices, and computer-executable instructions to obtain a temporary key, and distribute the temporary key to each of the computing devices, wherein each of the computing devices stores its copy of the key. Using the temporary key, the instructions establish a temporary secure communication channel with each of the computing devices, perform a task on each of the computing devices using the secure communication channel, and cancel the secure communication channel when the task is finished.

According to another embodiment, a temporary privileged cluster access method includes the steps of obtaining a temporary key, distributing the temporary key to each of a plurality of computing devices configured in a cluster, and using the key, establishing a temporary secure communication channel with each of the computing devices. Each of the computing devices stores its copy of the key. The method further includes the steps of performing a task on each of the computing devices using the secure communication channel, and canceling the secure communication channel when the task is finished.

According to yet another embodiment, a computer program product with a computer readable storage medium having program instructions stored thereon that, upon execution by an Information Handling System (IHS), cause the IHS to obtain a temporary key, distribute the temporary key to each of the computing devices, and using the key, establish a temporary secure communication channel with each of the computing devices. The instructions also cause the HIS to perform a task on each of the computing devices using the secure communication channel, and cancel the secure communication channel when the task is finished.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram illustrating an example of a computing environment where systems and methods described herein may be implemented.

FIG. 2 is a block diagram of components of IHS, which may be used to implement any of Host Devices or storage arrays as shown and described in FIG. 1.

FIG. 3 illustrates an example temporary privileged cluster access system that may be used to provide temporary privileged access to some, most, or all other nodes in a cluster according to one embodiment of the present disclosure.

FIG. 4 illustrates an example temporary privileged cluster access method that may be performed by the temporary privileged access system according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components.

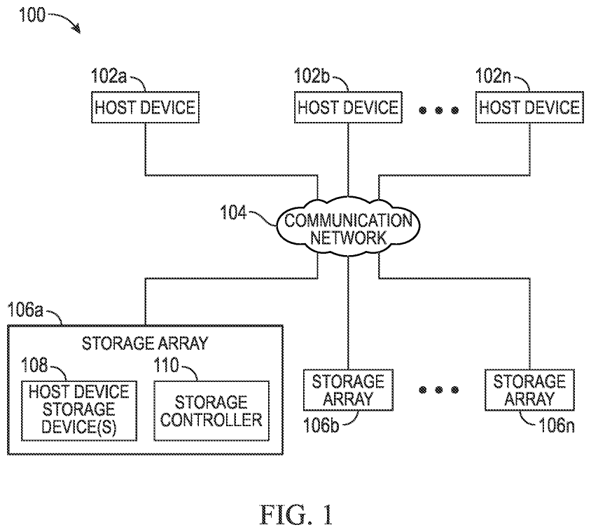

FIG. 1 is a diagram illustrating an example of a computing environment 100 where systems and methods described herein may be implemented. The computing environment 100 comprises one or more host devices 102A, 102B, and 102N (collectively 102) that communicate over a network 104 with one or more storage arrays 106A, 106B, and 106N (collectively 106). The network 104 may comprise a storage area network (SAN).

The storage array 106A, as shown, comprises multiple storage devices 108 each storing data utilized by one or more applications running on the host devices 102. The storage devices 108 may be arranged in one or more storage pools. The storage array 106A also includes one or more storage controllers 110 that facilitate I/O processing for the storage devices 108. The storage array 106A and its associated storage devices 108 are an example of what is more generally referred to herein as a “storage system.” This storage system in the present embodiment is shared by the host devices 102, and is therefore also referred to herein as a “shared storage system.” In embodiments where there is only a single host device 102, the host device 102 may be configured to have exclusive use of the storage system.

The host devices 102 illustratively comprise respective computers, servers or other types of processing devices capable of communicating with the storage arrays 106 via the network 104. For example, at least a subset of the host devices 102 may be implemented as respective virtual machines of a compute services platform or other type of processing platform. The host devices 102 in such an arrangement illustratively provide compute services such as execution of one or more applications on behalf of each of one or more users associated with respective ones of the host devices 102.

Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

The storage devices 108 of the storage array 106A may implement logical units (LUNs) configured to store objects for users associated with the host devices 102. These objects can comprise files, blocks or other types of objects. The host devices 102 may interact with the storage array 106A utilizing read and write commands as well as other types of commands that are transmitted over the network 104. Such commands in some embodiments more particularly comprise Small Computer System Interface (SCSI) commands, although other types of commands can be used in other embodiments. A given IO operation as that term is broadly used herein illustratively comprises one or more such commands. References herein to terms such as “input-output” and “IO” should be understood to refer to input and/or output. Thus, an IO operation relates to at least one of input and output. Also, the term “storage device” as used herein is intended to be broadly construed, so as to encompass, for example, a logical storage device such as a LUN or other logical storage volume. A logical storage device can be defined in the storage array 106A to include different portions of one or more physical storage devices. Storage devices 108 may therefore be viewed as comprising respective LUNs or other logical storage volumes.

In the computing environment 100, multiple ones of the storage arrays 106 can be assumed to be part of a storage cluster, while the host devices 102 are assumed to submit I/O operations to be processed by the storage cluster. At least one of the storage controllers of the storage arrays 106 (e.g., the storage controller 110 of storage array 106A) are assumed to implement storage cluster management functionality for the storage cluster. Such storage cluster management functionality may alternatively be implemented external to the storage arrays 106 of the storage cluster (e.g., such as on a dedicated server, on host devices 102, etc.).

The network 104 may be implemented using multiple networks of different types to interconnect storage system components. For example, the network 104 may comprise a SAN that is a portion of a global computer network such as the Internet, although other types of networks can be part of the SAN, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols. As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fiber Channel. Numerous alternative networking arrangements are possible in a given embodiment, as will be appreciated by those skilled in the art.

The storage devices 108 may include any suitable type. In one embodiment, the storage devices 108 of the storage array 106A can be implemented using solid state drives (SSDs). Such SSDs are implemented using non-volatile memory (NVM) devices such as flash memory. Other types of NVM devices that can be used to implement at least a portion of the storage devices 108 include non-volatile random access memory (NVRAM), phase-change RAM (PC-RAM) and magnetic RAM (MRAM). These and various combinations of multiple different types of NVM devices or other storage devices may also be used. For example, hard disk drives (HDDs) can be used in combination with or in place of SSDs or other types of NVM devices. Accordingly, numerous other types of electronic or magnetic media can be used in implementing at least a subset of the storage devices 108.

According to embodiments of the present disclosure, one of the storage controllers 110 may provide privileged temporary cluster access to other storage arrays 106 in the computing environment 100. In a containerized, multi-node, multi-appliance, clustered environment, security barriers may exist where certain nodes (e.g., storage arrays 106) only trust each other minimally using the principle of least privilege. Typically, pairs of nodes are grouped together to form an appliance for redundancy in which each pair of nodes fully trust each other for operations like allowing SSH access. This unrestricted access, however, often does not extend to the nodes of other pairs in the same cluster. The entire cluster may have a control path interface where commands can be sent using a specific API over a protected interface, but it typically is not open to arbitrary commands.

Situations may arise, however, where it may be beneficial to temporarily break those trust barriers and allow certain minimal privileges (e.g., SSH) access between some, most, or all the nodes (e.g., storage arrays) of the same cluster. For example, it may be useful during initial deployment or when a firmware update is to be performed to temporarily allow limited access to the devices so that firmware may be deployed in a quick and efficient manner. Additionally, it may be beneficial to check the collective status and/or perform a health check on the nodes in the cluster. As will be described in detail herein below, embodiments of the present disclosure provide a technique to temporarily allow limited access to some, most, or all nodes (e.g., storage arrays 106) in their associated cluster so that these, and other, collective processes may be efficiently performed.

The term “firmware,” as used herein, refers to a class of program instructions that provides low-level control for a device's hardware. Generally, firmware enables basic operations of a device and/or provides hardware abstraction services to higher-level software, such as an OS. The term “firmware installation package,” as used herein, refers to program instructions that, upon execution, deploy device drivers or services in an IHS or IHS component.

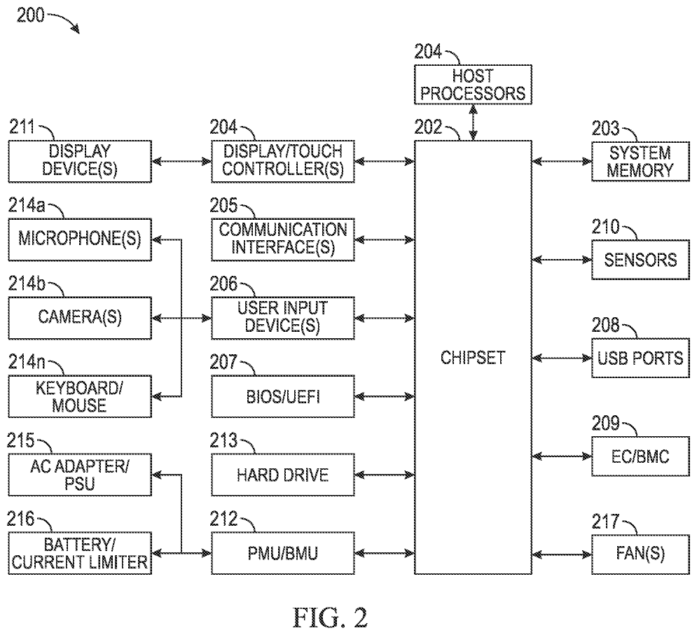

FIG. 2 is a block diagram of components of IHS 200, which may be used to implement any of Host Devices 102 or storage arrays 106 of FIG. 1. As depicted, IHS 200 includes host processor(s) 201. In various embodiments, IHS 200 may be a single-processor system, a multi-processor system including two or more processors, and/or a heterogeneous computing platform. Host processor(s) 201 may include any processor capable of executing program instructions, such as a PENTIUM processor, or any general-purpose or embedded processor implementing any of a variety of Instruction Set Architectures (ISAs), such as an x86 or a Reduced Instruction Set Computer (RISC) ISA (e.g., POWERPC, ARM, SPARC, MIPS, etc.).

IHS 200 includes chipset 202 coupled to host processor(s) 201. Chipset 202 may provide host processor(s) 201 with access to several resources. In some cases, chipset 202 may utilize a QuickPath Interconnect (QPI) bus to communicate with host processor(s) 201.

Chipset 202 may also be coupled to communication interface(s) 205 to enable communications between IHS 200 and various wired and/or wireless networks, such as Ethernet, WiFi, BLUETOOTH (BT), cellular or mobile networks (e.g., Code-Division Multiple Access or “CDMA,” Time-Division Multiple Access or “TDMA,” Long-Term Evolution or “LTE,” etc.), satellite networks, or the like.

Communication interface(s) 205 may also be used to communicate with certain peripherals devices (e.g., BT speakers, microphones, headsets, etc.). Moreover, communication interface(s) 205 may be coupled to chipset 202 via a Peripheral Component Interconnect Express (PCIe) bus, or the like.

Chipset 202 may be coupled to display/touch controller(s) 204, which may include one or more Graphics Processor Units (GPUs) on a graphics bus, such as an Accelerated Graphics Port (AGP) or PCIe bus. As shown, display/touch controller(s) 204 provide video or display signals to one or more display device(s) 211.

Display device(s) 211 may include Liquid Crystal Display (LCD), Light Emitting Diode (LED), organic LED (OLED), or other thin film display technologies. Display device(s) 211 may include a plurality of pixels arranged in a matrix, configured to display visual information, such as text, two-dimensional images, video, three-dimensional images, etc. In some cases, display device(s) 211 may be provided as a single continuous display, or as two or more discrete displays.

Chipset 202 may provide host processor(s) 201 and/or display/touch controller(s) 204 with access to system memory 203. In various embodiments, system memory 203 may be implemented using any suitable memory technology, such as static RAM (SRAM), dynamic RAM (DRAM) or magnetic disks, or any nonvolatile/Flash-type memory, such as a solid-state drive (SSD) or the like.

Chipset 202 may also provide host processor(s) 201 with access to one or more Universal Serial Bus (USB) ports 208, to which one or more peripheral devices may be coupled (e.g., integrated or external webcams, microphones, speakers, etc.).

Chipset 202 may further provide host processor(s) 201 with access to one or more hard disk drives, solid-state drives, optical drives, or other removable-media drives 213.

Chipset 202 may also provide access to one or more user input devices 206, for example, using a super I/O controller or the like. Examples of user input devices 206 may include, but are not limited to, microphone(s) 214A, camera(s) 214B, and keyboard/mouse 214N. Other user input devices 206 may include a touchpad, trackpad, stylus or active pen, totem, etc.

Each user input devices 206 may include a respective controller (e.g., a touchpad may have its own touchpad controller) that interfaces with chipset 202 through a wired or wireless connection (e.g., via communication interfaces(s) 205). In some cases, chipset 202 may also provide access to one or more user output devices (e.g., video projectors, paper printers, 3D printers, loudspeakers, audio headsets, Virtual/Augmented Reality (VR/AR) devices, etc.).

In certain embodiments, chipset 202 may further provide an interface for communications with hardware sensors 210.

Sensors 210 may be disposed on or within the chassis of IHS 200, or otherwise coupled to IHS 200, and may include, but are not limited to: electric, magnetic, radio, optical (e.g., camera, webcam, etc.), infrared, thermal (e.g., thermistors etc.), force, pressure, acoustic (e.g., microphone), ultrasonic, proximity, position, deformation, bending, direction, movement, velocity, rotation, gyroscope, Inertial Measurement Unit (IMU), and/or acceleration sensor(s).

The Unified Extensible Firmware Interface (UEFI) was designed as a successor to BIOS. As a result, many modern IHSs utilize UEFI in addition to or instead of a BIOS. As used herein, BIOS 207 is intended to also encompass a UEFI component.

Embedded Controller (EC) or Baseboard Management Controller (BMC) 209 is operational from the very start of each IHS power reset and handles various tasks not ordinarily handled by host processor(s) 201. Examples of these operations may include, but are not limited to: receiving and processing signals from a keyboard or touchpad, as well as other buttons and switches (e.g., power button, laptop lid switch, etc.), receiving and processing thermal measurements (e.g., performing fan control, CPU and GPU throttling, and emergency shutdown), controlling indicator LEDs (e.g., caps lock, scroll lock, number lock, battery, power, wireless LAN, sleep, etc.), managing PMU/BMU 212, alternating current (AC) adapter/Power Supply Unit (PSU) 215 and/or battery/current limiter 216, allowing remote diagnostics and remediation over network(s) 104, etc.

For example, EC/BMC 209 may implement operations for interfacing with power adapter/PSU 215 in managing power for IHS 200. Such operations may be performed to determine the power status of IHS 200, such as whether IHS 200 is operating from AC adapter/PSU 215 and/or battery 216.

Firmware instructions utilized by EC/BMC 209 may also be used to provide various core operations of IHS 200, such as power management and management of certain modes of IHS 200 (e.g., turbo modes, maximum operating clock frequencies of certain components, etc.).

In addition, EC/BMC 209 may implement operations for detecting certain changes to the physical configuration or posture of IHS 200. For instance, when IHS 200 is embodied as a 2-in-1 laptop/tablet form factor, EC/BMC 209 may receive inputs from a lid position or hinge angle sensor 210, and it may use those inputs to determine: whether the two sides of IHS 200 have been latched together to a closed position or a tablet position, the magnitude of a hinge or lid angle, etc. In response to these changes, the EC may enable or disable certain features of IHS 200 (e.g., front or rear facing camera, etc.).

In some cases, EC/BMC 209 may be configured to identify any number of IHS postures, including, but not limited to: laptop, stand, tablet, tent, or book. For example, when display(s) 211 of IHS 200 is open with respect to a horizontal keyboard portion, and the keyboard is facing up, EC/BMC 209 may determine IHS 200 to be in a laptop posture. When display(s) 211 of IHS 200 is open with respect to the horizontal keyboard portion, but the keyboard is facing down (e.g., its keys are against the top surface of a table), EC/BMC 209 may determine IHS 200 to be in a stand posture.

When the back of display(s) 211 is closed against the back of the keyboard portion, EC/BMC 209 may determine IHS 200 to be in a tablet posture. When IHS 200 has two display(s) 211 open side-by-side, EC/BMC 209 may determine IHS 200 to be in a book posture. When IHS 200 has two displays open to form a triangular structure sitting on a horizontal surface, such that a hinge between the displays is at the top vertex of the triangle, EC/BMC 209 may determine IHS 200 to be in a tent posture. In some implementations, EC/BMC 209 may also determine if display(s) 211 of IHS 200 are in a landscape or portrait orientation.

In some cases, EC/BMC 209 may be installed as a Trusted Execution Environment (TEE) component to the motherboard of IHS 200.

Additionally, or alternatively, EC/BMC 209 may be configured to calculate hashes or signatures that uniquely identify individual components of IHS 200. In such scenarios, EC/BMC 209 may calculate a hash value based on the configuration of a hardware and/or software component coupled to IHS 200. For instance, EC/BMC 209 may calculate a hash value based on all firmware and other code or settings stored in an onboard memory of a hardware component.

Hash values may be calculated as part of a trusted process of manufacturing IHS 200 and may be maintained in secure storage as a reference signature. EC/BMC 209 may later recalculate the hash value for a component, compare it against the reference hash value to determine if any modifications have been made to the component, thus indicating that the component has been compromised. In this manner, EC/BMC 209 may validate the integrity of hardware and software components installed in IHS 200.

In various embodiments, IHS 200 may be coupled to an external power source (e.g., AC outlet or mains) through an AC adapter/PSU 215. AC adapter/PSU 215 may include an adapter portion having a central unit (e.g., a power brick, wall charger, or the like) configured to draw power from an AC outlet via a first electrical cord, convert the AC power to direct current (DC) power, and provide DC power to IHS 200 via a second electrical cord.

Additionally, or alternatively, AC adapter/PSU 215 may include an internal or external power supply portion (e.g., a switching power supply, etc.) connected to the second electrical cord and configured to convert AC to DC. AC adapter/PSU 215 may also supply a standby voltage, so that most of IHS 200 can be powered off after preparing for hibernation or shutdown, and powered back on by an event (e.g., remotely via wake-on-LAN, etc.). In general, AC adapter/PSU 215 may have any specific power rating, measured in volts or watts, and any suitable connectors.

IHS 200 may also include internal or external battery 216. Battery 216 may include, for example, a Lithium-ion or Li-ion rechargeable device capable of storing energy sufficient to power IHS 200 for an amount of time, depending upon the IHS's workloads, environmental conditions, etc. In some cases, a battery pack may also contain temperature sensors, voltage regulator circuits, voltage taps, and/or charge-state monitors. For example, battery 216 may include a current limiter, or the like.

In some embodiments, battery 216 may be configured to detect overcurrent or undervoltage conditions using Limits Management Hardware (LMH). As used herein, the term “overcurrent” refers to a condition in an electrical circuit that arises when a normal load current is exceeded (e.g., overloads, short circuits, etc.). Conversely, the term “undervoltage” refers to a condition (e.g., “brownout”) where the applied voltage drops to X % of rated voltage (e.g., 90%), or less, for a predetermined amount of time (e.g., 1 minute).

Power Management Unit (PMU) 212 governs power functions of IHS 200, including AC adapter/PSU 215 and battery 216. For example, PMU 212 may be configured to: monitor power connections and battery charges, charging batteries, control power to other components, devices, or ICs, shut down components when they are left idle, control sleep and power functions (On and Off), managing interfaces for built-in keypad and touchpads, regulate real-time clocks (RTCs), etc.

In some implementations, PMU 212 may include one or more Power Management Integrated Circuits (PMICs) configured to control the flow and direction or electrical power in IHS 200. Particularly, a PMIC may be configured to perform battery management, power source selection, voltage regulation, voltage supervision, undervoltage protection, power sequencing, and/or charging operations. It may also include a DC-to-DC converter to allow dynamic voltage scaling, or the like.

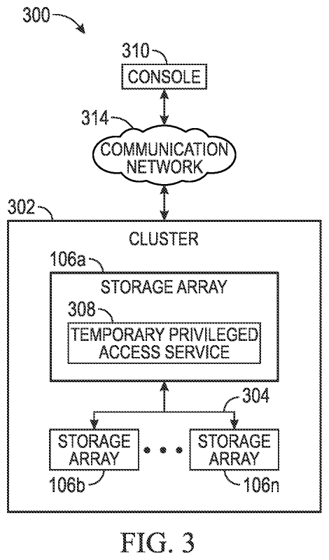

Additionally, or alternatively, PMU 212 may include a Battery Management Unit (BMU) (referred to collectively as “PMU/BMU 212”). AC adapter/PSU 215 may be removably coupled to a battery charge controller within PMU/BMU 212 to provide IHS 200 with a source of DC power from battery cells within battery 216 (e.g., a lithium ion (Li-ion) or nickel metal hydride (NiMH) battery pack including one or more rechargeable batteries). PMU/BMU 212 may include non-volatile memory and it may be configured to collect and store battery status, charging, and discharging information, and to provide that information to other IHS components, such as, for example devices within heterogeneous computing platform 300 (FIG. 3).

Examples of information collected and stored in a memory within PMU/BMU 212 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information (e.g., such as ambient temperature, relative humidity, system geolocation measured by GPS or triangulation, time and date, etc.), and BMU events.

Examples of BMU events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, power draw measurements may be conducted with control and monitoring of power supply via PMU/BMU 212. Power draw data may also be monitored with respect to individual components or devices of IHS 200. Whenever applicable, PMU/BMU 212 may administer the execution of a power policy, or the like.

IHS 200 may also include one or more fans 217 configured to cool down one or more components or devices of IHS 200 disposed inside a chassis, case, or housing. Fan(s) 217 may include any fan inside, or attached to, IHS 200 and used for active cooling. Fan(s) 217 may be used to draw cooler air into the case from the outside, expel warm air from inside, and/or move air across a heat sink to cool a particular IHS component. In various embodiments, both axial and sometimes centrifugal (blower/squirrel-cage) fans may be used.

In other embodiments, IHS 200 may not include all the components shown in FIG. 2. In other embodiments, IHS 200 may include other components in addition to those that are shown in FIG. 2. Furthermore, some components that are represented as separate components in FIG. 2 may instead be integrated with other components, such that all or a portion of the operations executed by the illustrated components may instead be executed by the integrated component.

For example, in various embodiments described herein, host processor(s) 201 and/or other components of IHS 200 (e.g., chipset 202, display/touch controller(s) 204, communication interface(s) 205, EC/BMC 209, etc.) may be replaced by discrete devices within heterogeneous computing platform 300 (FIG. 3). As such, IHS 200 may assume different form factors including, but not limited to: servers, workstations, desktops, laptops, appliances, video game consoles, tablets, smartphones, etc.

FIG. 3 illustrates an example temporary privileged cluster access system 300 that may be used to provide temporary privileged access to some, most, or all other nodes in a cluster according to one embodiment of the present disclosure. For example, the temporary privileged access system 300 may be implemented on the computing environment 100 as described above. The temporary privileged access system 300 includes a storage array 106A communicatively coupled to the other storage arrays 106 via a dedicated network 304. The network 304 may be similar to the communication network 314, or it may be an internal network separate and distinct from the network 314. In one embodiment, the dedicated network 304 is fire-walled off from the communication network 314 for security reasons.

According to embodiments of the present disclosure, the storage array 106A is configured with a temporary privileged access service 308 that manages temporary privileged access to the other nodes (e.g., storage arrays 106) in the cluster 302. In one embodiment, the temporary privileged access service 308 may be under the control of a console 310 that communicates with the storage array 106A via a network 314, such as the Internet. In other embodiments, the temporary privileged access service 308 may be responsive to any suitable entity for providing the various features of the embodiments described herein. In another embodiment, the temporary privileged access service 308 may be, or form a part of, one of the storage controllers 110 as described above with reference to FIG. 1.

The console 310 may comprise at least a portion of the IHS 200 described above with reference to FIG. 2. The console 310 may be any type that manages the operation of the cluster 302 and the storage arrays 106 configured in the cluster 302. For example, console 310 may include a systems management appliance such as the Dell EMC OpenManage Enterprise (OME) systems manager that is installed on a secure virtual machine (VM), such as a VMWARE Workstation. Additionally, the console 310 may be configured locally to the cluster 302 (e.g., housed in the same building as the cluster 302), or remotely over a communication network, such as the Internet.

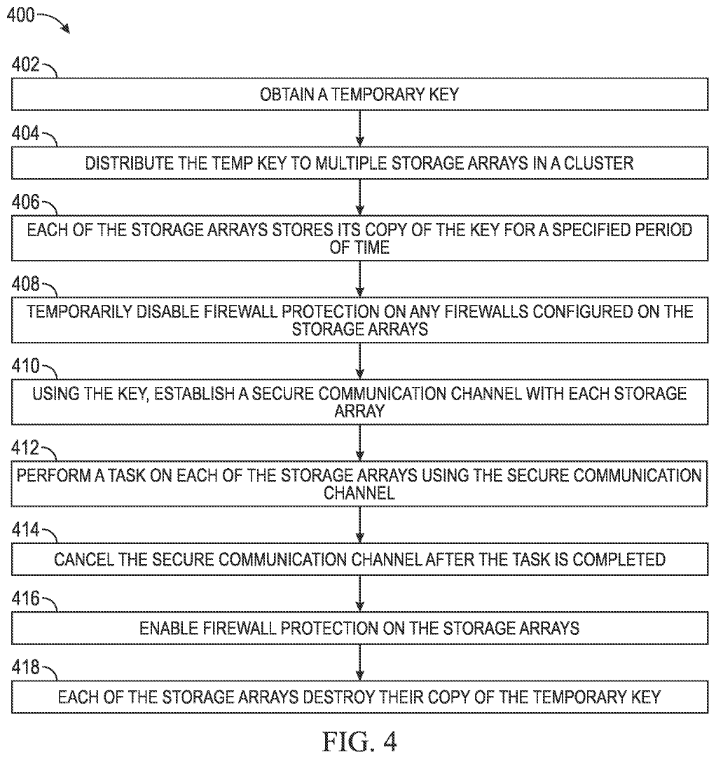

FIG. 4 illustrates an example temporary privileged cluster access method 400 that may be performed by the temporary privileged access system 300 according to one embodiment of the present disclosure. While the temporary privileged access method 400 is described herein as a technique for enabling temporary privileged access for a cluster of storage arrays, it is contemplated that the temporary privileged access method 400 may be applicable to any cluster of computing devices (e.g., IHSs) that otherwise have restricted access to one another. Additionally or alternatively, the temporary privileged access method 400 may be performed at least in part, by the temporary privileged access system 300 as described herein above with reference to FIG. 3. The temporary privileged access method 400 may be performed at any suitable time, such as whenever a task is to be collectively performed on some, most, or all of the nodes (e.g., storage arrays 106) of the cluster 302.

Initially at step 402, the method 400 obtains a temporary key. In one embodiment, the temporary privileged access service 308 generates temporary key internally, such as when a request is received to perform a certain task (e.g., perform a software update). In another embodiment, the temporary privileged access service 308 obtains a temporary key from an external source, such as console, which has received a request to perform a certain task. Thereafter at step 404, the method 400 distributes the temporary key to multiple storage arrays 106 in a cluster 302, and at step 406, each of the storage arrays 106 stores its copy of the key for a specified period of time.

In one embodiment, the method 400 may distribute the temporary key along with an elapsed time value indicating the specified period of time that the temporary key is to remain valid. In one embodiment, the elapsed time value for the temporary key may be hardcoded in each of the other storage arrays 106. In another embodiment, the method 400 may determine an elapsed time value according to a type of task to be performed. For example, if the task is to be a firmware update, it may determine that the elapsed time value should be 30 minutes, and if the task is to check status, it may determine that the elapsed time value should be 5 minutes.

At step 408, the method 400 temporarily disables firewall protection for specific traffic that is protected by another security protocol configured on its hosting storage array 106A, and on the other storage arrays 106B-N. In one embodiment, the method 400 temporarily disables firewall protection for Secure Shell (SSH) traffic that is protected by Internet Protocol Security (IPSEC) on IPv6 networks on its hosting storage array 106A, and on the other storage arrays 106B-N. For example, each storage array 106 may be configured with a firewall that restricts communication traffic to any node with the exception of the host device(s) 102 to which it is configured to function with. This would preclude access to the method 400 and any task that could otherwise be performed. Thus, by temporarily disabling some firewall protection (e.g., opening a relatively small hole in the firewall), the temporary privileged access method 400 is able to perform its assigned task free of any hindrance, so long as those tasks are still protected by IPSEC. That is, the temporarily disabled part of the firewall only allows for SSH traffic over IPv6, which is also protected by IPSEC.

At step 410, using the key, the method 400 establishes a secure communication channel with each storage array 106. For example, to establish secure communication channel, the method 400 may issue the obtained temporary key to each of the storage arrays 106, which each storage array 106 in turn, stores in its secure key storage. Each storage array 106 may also store the elapsed time value indicating an amount of time to wait until the temporary key is to be destroyed. In one embodiment, the secure communication channel may be an Internet Protocol Security (IPSEC) connection, such as a Secure Shell (SSH) connection. In another embodiment, the secure communication channel is established using an Internet Protocol Version 6 (IPV6) protocol, which is relatively more secure than the IPV4 protocol.

At step 412, the method 400 performs a task on each of the storage arrays 106 using the secure communication channel. The task to be performed may be any suitable type. Examples of such types of tasks may include performing a firmware update, checking the status of the other storage arrays 106, and/or performing a collective health check on each of the storage arrays 106. In another embodiment, temporary privileged access method 400 may maintain a whitelist of commands that are allowed to be issued to the other storage arrays 106. That is, the temporary privileged access method 400 may only be responsive to certain commands (e.g., firmware update) to perform the steps of the method 400 described herein, while rejecting all other commands. For example, the temporary privileged access service 308 may respond to a command that instructs it to perform a firmware update, while rejecting all other commands issued to it.

In another embodiment, the method 400 may only process commands issued from algorithm(s) performed by either the temporary privileged access service 308 or from the remote console 310. That is, the method 400 may restrict some, or all tasks from being performed manually by a user. For example, when the temporary privileged access service 308 receives the command to perform the firmware update, it may then, using its algorithms, perform the steps of the method 400 described herein to enable temporary privileged access service to the other storage arrays 106 independently of any manual intervention so that the firmware update can be performed on each of the storage arrays 106. Reducing and/or eliminating manual intervention may be beneficial in mitigating any potential security risk posed by users purposefully or inadvertently causing damage to the storage arrays and/or data stored on the storage arrays 106.

After the task has been completed on each of the storage arrays 106, the method 400 cancels the secure communication channel at step 414, and at step 416, the method 400 enables the part of the firewall protection on the storage arrays 106 that was previously disabled at step 408. Thereafter at step 418, the temporary privileged access service 308 and the other storage arrays 106 each destroy their copy of the temporary key.

The steps of the aforedescribed process may be performed each time one or more tasks are to be collectively performed on the storage arrays 106 of the cluster 302. Nevertheless, when use of the temporary privileged access method 400 is no longer needed or desired, the temporary privileged access method 400 ends.

Although FIG. 4 describes an example method 400 that may be performed to provide temporary privileged access to some, most, or all nodes in a cluster, the features of the method 400 may be embodied in other specific forms without deviating from the spirit and scope of the present disclosure. For example, the method 400 may perform additional, fewer, or different operations than those described in the present examples. For another example, the method 400 may be performed in a sequence of steps different from that described above. As yet another example, certain steps of the method 400 may be performed by other components than those described above.

In accordance with the foregoing, embodiments of the present systems and methods provide secure temporary privileged access to nodes in a cluster. To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). This may include selecting predefined logic blocks and logically associating them. It may also include programming computer software-based logic of a retrofit control device, wiring discrete hardware components, or a combination thereof. Such configured devices are physically designed to perform the specified operation(s).

Various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS) comprising:
a cluster comprising a plurality of computing devices; and
at least one memory coupled to at least one processor, the at least one memory having program instructions stored thereon that, upon execution by the at least one processor, cause the instructions to:
obtain a temporary key;
distribute the temporary key to each of the computing devices, wherein each of the computing devices stores its copy of the key;
using the key, establish a temporary secure communication channel with each of the computing devices;
perform a task on each of the computing devices using the secure communication channel; and
cancel the secure communication channel when the task is finished.

2. The IHS of claim 1, wherein the program instructions, upon execution, further cause IHS to:
generate an elapsed time value specifying an amount of time that the temporary key is to remain valid; and
distribute the elapsed time value to each of the computing devices when the temporary key is distributed.

3. The IHS of claim 2, wherein the program instructions, upon execution, further cause IHS to determine the elapsed time value based upon a type of the task to be performed.

4. The IHS of claim 1, wherein the program instructions, upon execution, further cause IHS to establish the temporary secure communication channel according to an Internet Protocol Secure (IPSEC) protocol.

5. The IHS of claim 1, wherein the program instructions, upon execution, further cause IHS to disable at least one restriction in a firewall of each of the computing devices.

6. The IHS of claim 5, wherein the program instructions, upon execution, further cause IHS to enable the at least one restriction when the secure communication channel is canceled.

7. The IHS of claim 1, wherein the program instructions, upon execution, further cause IHS to restrict manual establishment of the temporary secure communication channel.

8. The IHS of claim 1, wherein the computing devices comprise a plurality of storage arrays.

9. The IHS of claim 1, wherein the program instructions, upon execution, further cause IHS to destroy the temporary key to cancel the secure communication channel.

10. The IHS of claim 1, wherein the program instructions are performed by one of the computing devices.

11. A temporary privileged cluster access method comprising:
obtaining a temporary key;
distributing the temporary key to each of a plurality of computing devices configured in a cluster, wherein each of the computing devices stores its copy of the key;
using the key, establishing a temporary secure communication channel with each of the computing devices;
performing a task on each of the computing devices using the secure communication channel; and
canceling the secure communication channel when the task is finished.

12. The temporary privileged access method of claim 11, further comprising:
generating an elapsed time value specifying an amount of time that the temporary key is to remain valid; and
distributing the elapsed time value to each of the computing devices when the temporary key is distributed.

13. The temporary privileged access method of claim 12, further comprising determining the elapsed time value based upon a type of the task to be performed.

14. The temporary privileged access method of claim 11, further comprising establishing the temporary secure communication channel according to an Internet Protocol Secure (IPSEC) protocol.

15. The temporary privileged access method of claim 11, further comprising disabling at least one restriction in a firewall of each of the computing devices.

16. The temporary privileged access method of claim 15, further comprising enabling the at least one restriction when the secure communication channel is canceled.

17. The temporary privileged access method of claim 11, further comprising restricting manual establishment of the temporary secure communication channel.

18. The temporary privileged access method of claim 11, further comprising destroying the temporary key to cancel the secure communication channel.

19. A computer program product comprising a computer readable storage medium having program instructions stored thereon that, upon execution by an Information Handling System (IHS), cause the IHS to:
obtain a temporary key;
distribute the temporary key to each of the computing devices, wherein each of the computing devices stores its copy of the key;
using the key, establish a temporary secure communication channel with each of the computing devices;
perform a task on each of the computing devices using the secure communication channel; and
cancel the secure communication channel when the task is finished.

20. The IHS of claim 1, wherein the program instructions, upon execution, further cause IHS to:
determine an elapsed time value based upon a type of the task to be performed, wherein the elapsed time value specifies an amount of time that the temporary key is to remain valid; and
distribute the elapsed time value to each of the computing devices when the temporary key is distributed.
